(19) United States
(12) Patent Application Publication
(10) Pub. No.: US 2015/0130632 A1
(43) Pub. Date: May 14, 2015

(54) DATA-COLLECTING SYSTEM AND DEVICE

(71) Applicant: ACE DRAGON CORP., Hukou Township (TW)

(72) Inventor: Min-Jen TSAO, Hukou Township (TW)

(21) Appl. No.: 14/527,351

(22) Filed: Oct. 29, 2014

(30) Foreign Application Priority Data
Nov. 8, 2013 (TW) 102220915

(51) Int. Cl. H04Q 9/02

(52) U.S. Cl. CPC H04Q 9/02
USPC 340/870.07

(57) ABSTRACT

A data-collecting system includes a host, a data-collecting device and at least one extended data-collecting device. The data-collecting device for collecting environment data generated by an environment-control box includes a port, a collector-processing unit, a first transmit port and a second transmit port. The port is electrically coupled with the environment-control box. The collector-processing unit is electrically coupled with the port. The first transmit port electrically coupled with the collector-processing unit is further electrically coupled to the host via a first transmission cable. The second transmit port is electrically coupled with the collector-processing unit. The extended data-collecting device is electrically coupled with the second transmit port via a second transmission cable so as to collect extended environment data generated by an extended environment-control box.

This application claims the benefit of Taiwan Patent Application Serial No. 102220915, filed Nov. 8, 2013, the subject matter of which is incorporated herein by reference.

### BACKGROUND OF INVENTION

1. Field of the Invention

The invention relates to a data-collecting system and a data-collecting device of the same system, and more particularly to the data-collecting system that utilizes a plurality of inter-linked data-collecting devices to collect environment data generated by a plurality of environment-control boxes.

2. Description of the Prior Art

Generally speaking, in ordinary manufacturing industry, products, semi-finished or finished, are usually stored in an environment-controlled room to avoid possible damages resulted from unexpected environmental risk. For example, hi-tech and precision products like optical elements, semiconductor components and any the like are usually sensitively to environmental variations, specifically in temperature and moisture. Hence, the environmental control for storing these aforesaid products is essential.

In the art, to store the aforesaid precision products effectively, a temperature-and-humidity environment-control box is usually applied to reduce the influence of the environmental changes. Specifically, while in managing a plurality of the environment-control boxes for storing a huge amount of these products, two methods are usually seen. One is to have the environment-control boxes to be operated independently and individually. Another is to link all these environment-control boxes with a host so as to perform a central control pattern among these environment-control boxes. However, in this central control pattern, the host needs plenty of ports to link individually with these environment-control boxes, and thus it is inevitable that a problem of complicated wiring among these environment-control boxes and the host in the installation site would rise, which will definitely lead to a reduced-mobility situation to the work space.

### SUMMARY OF THE INVENTION

As stated above, because the current technology generally links the environment-control boxes individually to the host and plenty wiring between the environment-control boxes and the host usually complicates the installation site, so the work space there-around is substantially limited and labors therein would be vulnerable to risks while working in such a complicated environment.

Accordingly, it is the primary object of the present invention to provide a data-collecting system, in which a plurality of data-collecting devices are linked in series so as to forward the environment data collected by respective environment controllers to a host in a convergent flowing manner. Upon such an arrangement, usage of wiring for connecting each data-collecting device to the host would be reduced, and thus the installation site can be concise and the work space can be safer to the labors.

In the present invention, the data-collecting device for collecting environment data generated by a respective environment-control box and for transferring the environment data to a host includes a port, a collector-processing unit, a first transmit port and a second transmit port. These two ports are electrically coupled with (i.e. connected to) the environment-control box so as to receive the environment data. The collector-processing unit is electrically coupled with the two ports so as to introduce the environment data through the respective ports. The first transmit port electrically coupled with the collector-processing unit at one end is further electrically coupled to the host at another end via a first transmission cable so as to transfer the environment data from the collector-processing unit to the host. The second transmit port electrically coupled with the collector-processing unit is further electrically coupled to at least one extended data-collecting device via a second transmission cable. The extended data-collecting device electrically coupled with an extended environment-control box is to collect extended environment data generated by the extended environment-control box and to forward the extended environment data to the host via the data-collecting device.

In the present invention, the data-collecting device can apply the first transmit port and the second transmit port to connect the host and other data-collecting devices so as to collect environment data generated by the respective environment-control boxes of the corresponding data-collecting devices. The data-collecting devices are connected in series and connect to the host for data-transmission thereto, such that the complicated wiring problem in the art can be resolved.

In one embodiment of the present invention, the data-collecting device further includes a display module electrically coupled with the collector-processing unit. Preferably, the display module includes a display screen, an indicating light and a control button. The display screen is to display outdoor environment data of the environment data, in which the outdoor environment data includes an outdoor temperature and an outdoor humidity. The indicating light is to indicate one of the outdoor temperature and the outdoor humidity displayed on the display screen. The control button is for the user to control the outdoor environment data displayed on the display screen.

In the present invention, the data-collecting device of the present invention further includes a display module so that the outdoor environment data detected by the environment-control box can be displayed by the display module. Also, the user can use the control button to control the display screen to display the outdoor environment data.

In one embodiment of the present invention, the data-collecting device further includes an extension port electrically coupled with the collector-processing unit is to electrically connect a wireless transmission module.

In the present invention, the data-collecting device further includes an extension port. As the data-collecting device is away from the host, the user can apply the wireless transmission module to perform data transmission through the extension port.

In one embodiment of the present invention, the first transmit port and the second transmit port are both RS485 connectors.

In one embodiment of the present invention, the port is a DB9 connector.

In one embodiment of the present invention, the data-collecting device further includes a power port, a power port electrically coupled with the collector-processing unit and the environment-control box.

In the present invention, the data-collecting device can adopt the power from the respective environment-control box so as to enhance the convenience of the installation.

It is another object of the present invention to provide a data-collecting system that includes a host, a data-collecting device and at least one extended data-collecting device. The data-collecting device for collecting environment data generated by an environment-control box includes a port, a collector-processing unit, a first transmit port and a second transmit port. The port electrically coupled with the environment-control box is to receive the environment data. The collector-processing unit electrically coupled with the port is to collect the environment data through the port. The first transmit port electrically coupled with the collector-processing unit is to electrically couple the host via a first transmission cable so as to have the environment data collected by the collector-processing unit to be transmitted to the host. The second transmit port is electrically coupled with the collector-processing unit. The extended data-collecting device applies a second transmission cable to electrically couple the second transmit port. The extended data-collecting device electrically coupled with the extended environment-control box is to collect extended environment data generated by the extended environment-control box, so that the extended environment data can be transmitted to the host via the data-collecting device.

In the present invention, the data-collecting system has all the data-collecting devices to be connected in a serial manner, and has the host to electrically couple with the data-collecting device, such that the environment data generated by the plural environment-control boxes can be transmitted to the host. Thereby, the amount of cables for connecting the individual data-collecting devices to the host can be significantly reduced.

In one embodiment of the present invention, the system may have a plurality of the extended data-collecting devices connected in a serial manner. Preferably, each of the extended data-collecting devices includes an extended port, an extended collector-processing unit, an extended first transmit port and an extended second transmit port. The extended port is electrically coupled with the extended environment-control box so as to receive the extended environment data. The extended collector-processing unit electrically coupled with the extended port is to go through the extended port to collect the extended environment data. The extended first transmit port is electrically coupled with the extended collector-processing unit. The extended second transmit port is electrically coupled with the extended collector-processing unit. In this system, the extended data-collecting devices are connected in a serial manner via the extended first transmit ports at one ends and the extended second transmit ports at another ends, in which one of the extended data-collecting device provides an extended first transmit port to connect the second transmission cable and further to electrically couple the second transmit port via the second transmission cable.

In one embodiment of the present invention, data-collecting system further includes a hub electrically coupled with the host. The system also has a plurality of the data-collecting devices and a plurality of the extended data-collecting devices. The first transmit port of the individual data-collecting device is to electrically couple the hub via the first transmission cable, while the extended first transmit port of the individual extended data-collecting device is electrically coupled to the second transmit port of the data-collecting device via the second transmission cable.

In the present invention, the data-collecting system can further apply the hub to electrically couple a plurality of the data-collecting devices, such that various data-collecting devices can be applied to collect data, and thus the associated convenience can be improved.

All these objects are achieved by the data-collecting system and device described below.

### BRIEF DESCRIPTION OF THE DRAWINGS

The present invention will now be specified with reference to its preferred embodiment illustrated in the drawings, in which:

FIG. 1 is a schematic perspective view of a data-collecting device of a first embodiment in accordance with the present invention;

FIG. 2 is another view of FIG. 1;

FIG. 3 demonstrates schematically in a block diagram a preferred linking of the data-collecting device of FIG. 1 and an environment-control box;

FIG. 4 demonstrates schematically a data-collecting system of a second embodiment in accordance with the present invention;

FIG. 5 demonstrates schematically a data-collecting system of a third embodiment in accordance with the present invention;

FIG. 6 illustrates an application of mounting the data-collecting devices into an environment-control box in accordance with the present invention;

FIG. 7 illustrates an application of mounting the data-collecting devices into an environment-control board in accordance with the present invention;

FIG. 8 demonstrates schematically in a block diagram a preferred linking of the data-collecting device and an environment-control box of a fourth embodiment in accordance with the present invention; and

FIG. 9 is a schematic block view of a data-collecting system of a fifth embodiment in accordance with the present invention.

### DESCRIPTION OF THE PREFERRED EMBODIMENT

The invention disclosed herein is directed to a data-collecting system and a data-collecting device for the same system. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

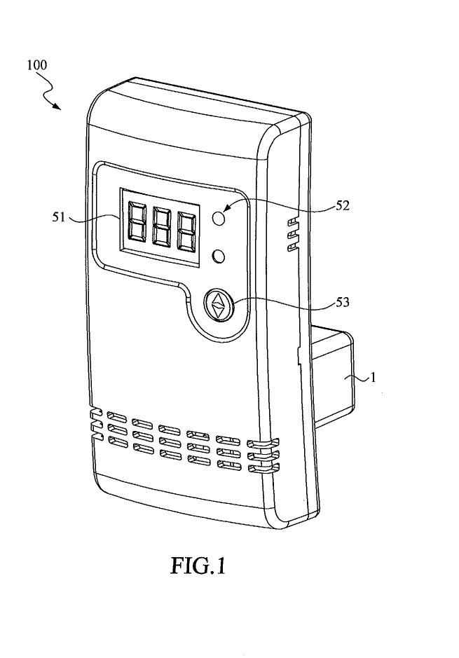

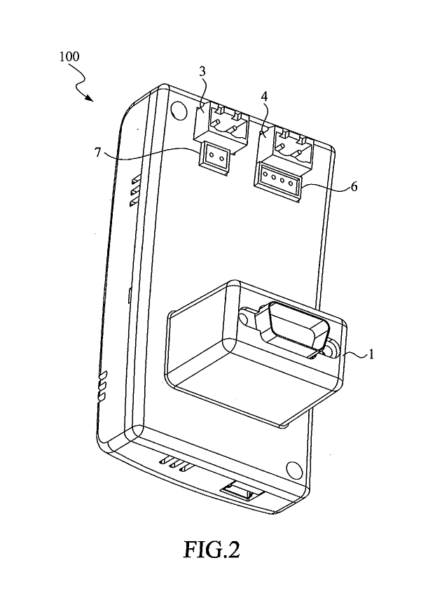

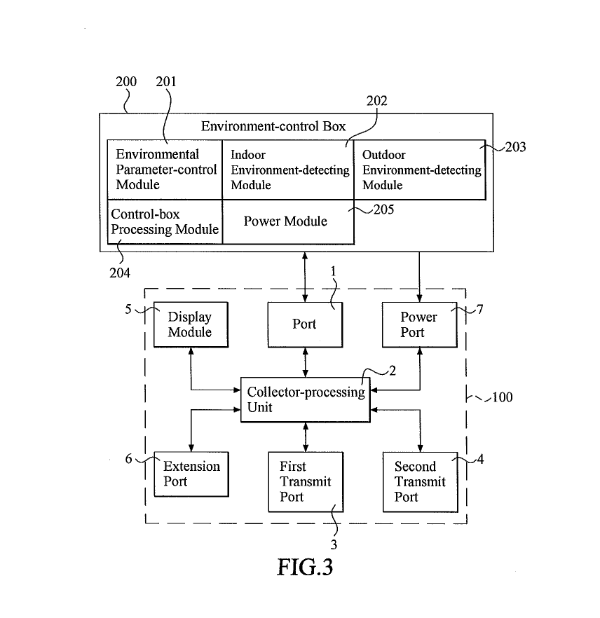

Refer now to FIG. 1 through FIG. 3, in which FIG. 1 is a schematic perspective view of a data-collecting device of a first embodiment in accordance with the present invention, FIG. 2 is another view of FIG. 1, and FIG. 3 demonstrates schematically in a block diagram a preferred linking of the data-collecting device of FIG. 1 and an environment-control box.

As shown, the data-collecting device 100 includes a port 1, a collector-processing unit 2, a first transmit port 3, a second transmit port 4, a display module 5, an extension port 6 and a power port 7. The data-collecting device 100 is to collect environment data generated by an environment-control box 200, and further to forward the environment data to a host. The environment-control box 200 includes an environmental parameter-control module 201, an indoor environment-detecting module 202, an outdoor environment-detecting module 203, a control-box processing module 204 and a power module 205. The environmental parameter-control module 201 is to control the environmental parameters of a storage space of the environment-control box 200. The indoor environment-detecting module 202 is to detect indoor environment data (such as temperature and humidity) of the storage space of the environment-control box 100. The outdoor environment-detecting module 203 is to detect outdoor environment data (such as outdoor temperature and humidity) of the storage space of the environment-control box 100. The control-box processing module 204 is electrically coupled with the environmental parameter-control module 201, the indoor environment-detecting module 202, the outdoor environment-detecting module 203 and the power module 205.

The port 1 for receiving the incoming environment data is electrically coupled with the control-box processing module 204 of the environment-control box 200, in which the environment data includes the aforesaid indoor environment data and outdoor environment data. The collector-processing unit 2 is electrically coupled with the port 1 so as to collect the environment data produced by the environment-control box 100 via the port 1. The first transmit port 3 is internally electrically coupled with the collector-processing unit 2 at one end and is externally electrically coupled to a host (not shown in the figure) at another end. The second transmit port 4 is electrically coupled internally with the collector-processing unit 2 and externally to an extended data-collecting device (not shown in the figure). In practice, the port 1 can be a DB9 connector, the collector-processing unit 2 can be a microprocessor, and each of the first transmit port 3 and the second transmit port 4 can be an RS485 connector.

The display module 5 electrically coupled with the collector-processing unit 2 includes a display screen 51, an indicating light 52 and a control button 53. The display screen 51 is to display the outdoor environment data having an outdoor temperature and an outdoor humidity. The indicating light 52 is to indicate one of the outdoor temperature and the outdoor humidity displayed on the display screen 51. The control button 53 is for the user to choose the outdoor environment data and the startup record to be displayed on the display screen 51.

The extension port 6 is electrically coupled internally with the collector-processing unit 2 and externally to a wireless transmission module (not shown in the figure) so as to transmit the environment data through the wireless transmission module.

The power port 7 is electrically coupled with the collector-processing unit 2 and the power module 205 of the environment-control box 200 so as to be energized by the environment-control box 200 and further to operate the data-collecting device 100.

As described above, the data-collecting device 100 of the present invention is electrically coupled to the environment-control box 200 via the port 1 so as to transmit the indoor environment data and the outdoor environment data generated respectively by the indoor environment-detecting module 202 and the outdoor environment-detecting module 203 of environment-control box 200 to the host. The user can also issue a control command at the host end to the environment-control box 200 through the data-collecting device 100, such that the humidity or the temperature of the environment-control box 200 can be controlled in a remote manner.

Further, in this embodiment, a mini USB slot (not shown in the figure) can be also constructed to the bottom of the data-collecting device 100. By providing the mini USB slot, the user can then couple electrically the data-collecting device 100 directly to an electronic device.

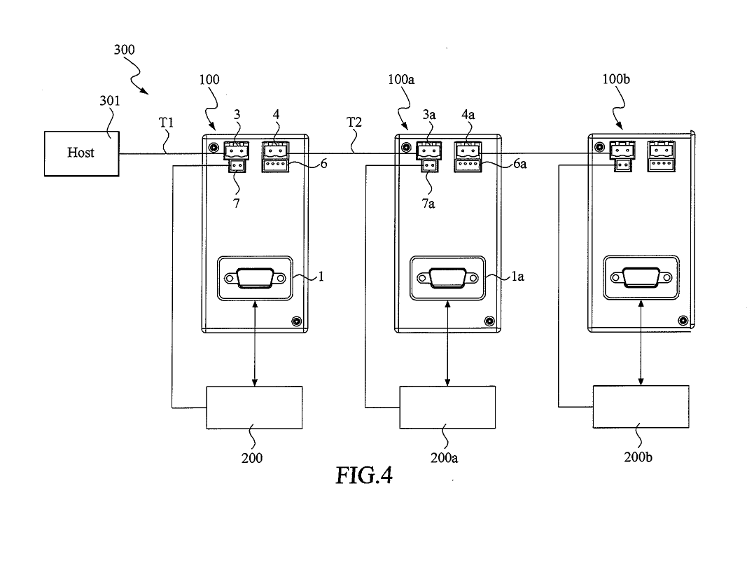

Refer now to FIG. 3 and FIG. 4, in which FIG. 4 demonstrates schematically a data-collecting system of a second embodiment in accordance with the present invention. As shown, the data-collecting system 300 includes a host 301, the data-collecting device 100, an extended data-collecting device 100a and another extended data-collecting device 100b. The first transmit port 3 of the data-collecting device 100 is electrically connected to the host 301 via a first transmission cable T1 so as to transmit the environment data collected by the environment-control box 2 to the host 301.

The extended data-collecting device 100a includes an extended port 1a, an extended collector-processing unit (not shown in the figure), an extended first transmit port 3a, an extended second transmit port 4a, an extended display module (not shown in the figure), an extension port 6a and an extended power port 7a.

The extended port 1a is electrically coupled with an extended environment-control box 200a so as to receive the extended environment data generated by the extended environment-control box 200a. The extended collector-processing unit is electrically coupled with the extended port 1a so as to collect the extended environment data through the extended port 1a. The extended first transmit port 3a is electrically coupled with the extended collector-processing unit. The extended second transmit port 4a is electrically coupled with the extended collector-processing unit. It is noted that the extended data-collecting device 100a and the aforesaid data-collecting device 100 are the same device, except that the extended first transmit port 3a of the extended data-collecting device 100a is electrically coupled to the second transmit port 4 of the data-collecting device 100 via a second transmission cable T2 so that the extended environment data collected at the extended environment-control box 200a can be transmitted to the host 301 through the data-collecting device 100.

In addition, the extended data-collecting device 100a is electrically coupled, through the extended second transmit port 4a thereof, to the same structured extended data-collecting device 100b, such that the extended environment data collected by the extended environment-control box 200b can be transmitted to the extended data-collecting device 100a, then the data-collecting device 100, and finally the host 301.

As described above, in this embodiment, the data-collecting device 100, the extended data-collecting device 100a and the another extended data-collecting device 100b are all the same device, except for the connections. As shown in FIG. 4, in a serial connection manner, the data-collecting device 100 is electrically coupled to the host 301, the extended data-collecting device 100a is electrically coupled to the data-collecting device 100, and the further extended data-collecting device 100b is electrically coupled to the extended data-collecting device 100a. Upon such an arrangement, environment data collected either by the environment-control box 200 or the two extended environment-control boxes 200a, 200b can be transmitted to the host 301 through the in-serial connection of the data-collecting devices 100, 100a, 100b. Further, the user can issue a control command at the host 301 end to perform controls of the environment parameters at any of the environment-control boxes 200, 200a, 200b via the data-collecting device 100, 100a, 100b, respectively.

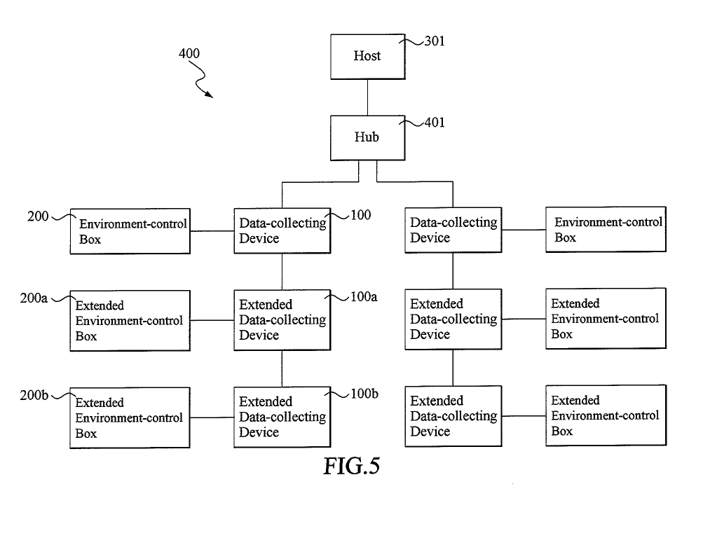

Refer now to FIG. 5, in which a data-collecting system of a third embodiment in accordance with the present invention is demonstrated schematically. As shown, the data-collecting system 400 includes the host 301, a hub 401, two data-collecting devices 100 (one labeled in the figure) and four extended data-collecting devices 100a, 100b (two labeled in the figure).

In this embodiment, the hub 401 is electrically coupled with the host 301. The data-collecting device 100 is connected electrically to the hub 401 at one end and the environment-control box 200 at another end thereof. The extended data-collecting device 100a is electrically connected to the data-collecting device 100 at one end and the extended environment-control box 200a at another end thereof. The extended data-collecting device 100b is connected electrically to the extended data-collecting device 100a at one end and the extended environment-control box 200b at another end thereof.

As described, the data-collecting system 400 of the present invention can further include the hub 401, and the host 301 can electrically couple the two data-collecting devices 100, in which each of the data-collecting device 100 can connect in series the extended data-collecting devices 100a, 100b. Upon such an arrangement, the host 301 can collect the environment data through the hub 401, and also the alignment wiring (i.e., in-serial connection) of the data-collecting device 100 and the extended data-collecting device 100a, 100b can simplify the arrangement of the connection cables.

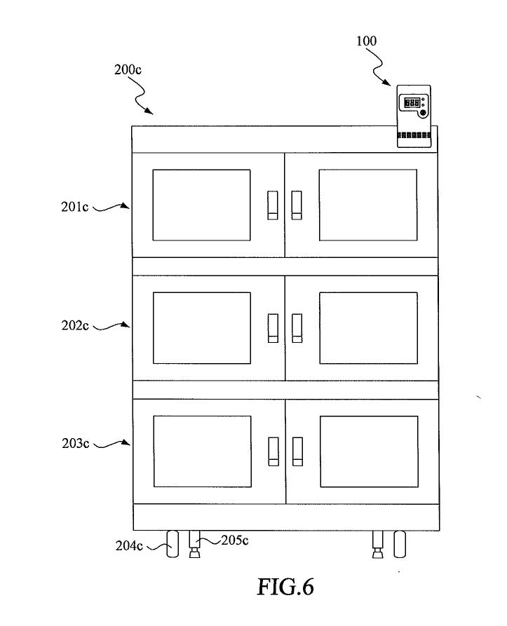

Refer no to FIG. 6, in which an application of mounting the data-collecting devices into an environment-control box in accordance with the present invention is illustrated schematically. As shown, the environment-control box 200c includes three stories of environment-control units 201c, 202c, 203c. Under the lowest environment-control unit 203c, four rollers 204c and two supportive columns 205c are provided. The data-collecting device 100 is plugged at top of the upper environment-control box 200c for a distant user able to collect environment data generated by the environment-control units 201c, 202c, 203c of the environment-control boxes 200c and also for the user able to control the environment parameters for the environment-control units 201c, 202c, 203c.

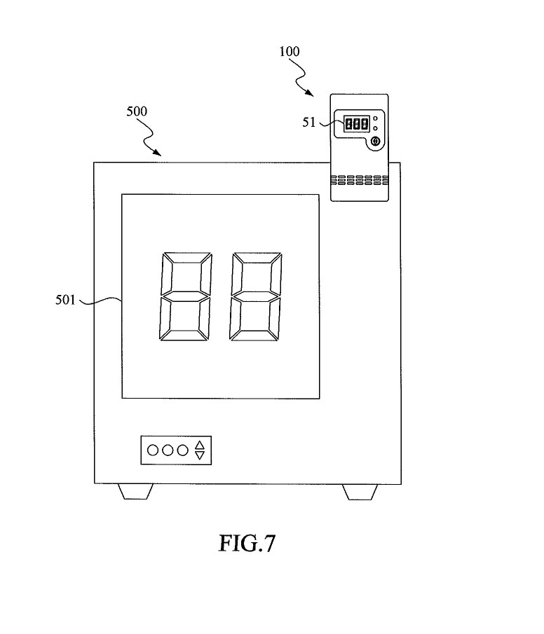

Refer now to FIG. 7, an application of mounting the data-collecting devices into an environment-control board in accordance with the present invention is illustrated. As shown, the data-collecting device 100 plugged at the environment board 500 that is able to be fixed to a wall is electrically coupled with an environment-control box (not shown in the figure) so as to display the environment data such as the outdoor temperature and the outdoor humidity detected by the environment-control box. The environment data can also be transmitted to the host through the data-collecting device 100. Limited by the size of the display screen 51 of the data-collecting device 100, in the case that a distant user is interested in the environment data generated by the environment-control box, the environment board 500 wired between the data-collecting device 100 and the environment-control box can be used to display the enlarged environment data originally displayed on the display screen 501.

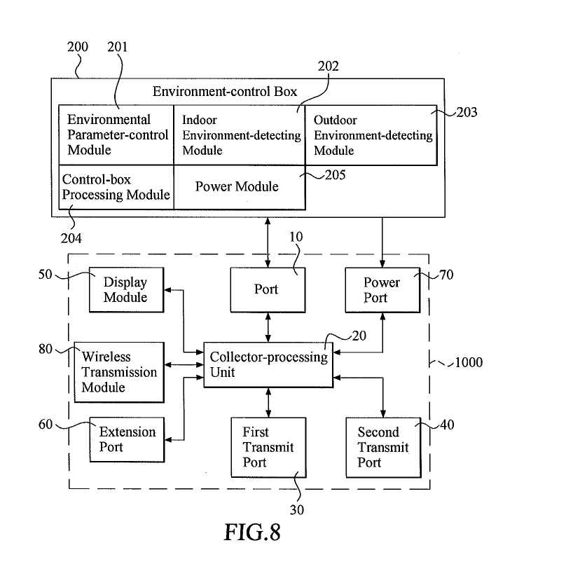

Refer now to FIG. 8, a preferred linking of the data-collecting device and an environment-control box of a fourth embodiment in accordance with the present invention is demonstrated schematically in a block diagram. As shown, the data-collecting device 1000 includes a port 10, a collector-processing unit 20, a first transmit port 30, a second transmit port 40, a display module 50, an extension port 60, a power port 70 and a wireless transmission module 80. In the data-collecting device 1000, the port 10, the collector-processing unit 20, the first transmit port 30, the second transmit port 40, the display module 50, the extension port 60 and the power port 70 are integrated to perform the same functions of the port 1, the collector-processing unit 2, the first transmit port 3, the second transmit port 4, the display module 5, the extension port 6 and the power port 7 of the aforesaid data-collecting device 100, respectively. Hence, details thereabout are omitted herein.

In this embodiment, the data-collecting device 1000 further includes a wireless transmission module 80 electrically coupled with the collector-processing unit 20 for wireless transmitting the environment data generated by the environment-control box 200 through the port 10.

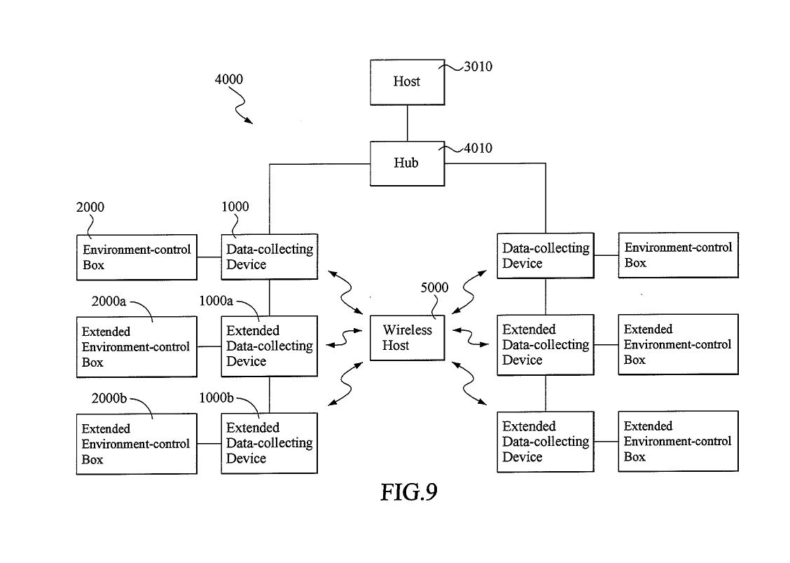

Refer now to FIG. 9, a schematic block view of a data-collecting system of a fifth embodiment in accordance with the present invention is shown. The data-collecting system 4000 includes a host 3010 (same as the foregoing host 301), a hub 4010, two data-collecting devices 1000 (one labeled in the figure), four extended data-collecting device 1000a, 1000b (two labeled in the figure) and a wireless host 5000.

The hub 4010 is electrically coupled with the host 3010. The data-collecting device 1000 is electrically cabled to the hub 4010 at one end and the environment-control box 2000 at another end thereof. The extended data-collecting device 1000a is cabled electrically to the data-collecting device 1000 at one end and the extended environment-control box 2000a at another end thereof. The extended data-collecting device 1000b is cabled electrically to the extended data-collecting device 1000a at one end and the extended environment-control box 2000b at another end thereof.

In addition, either the extended data-collecting device 1000a or the extended data-collecting device 1000b is structured the same as the data-collecting device 1000. The data-collecting device 1000, the extended data-collecting device 1000a and the extended data-collecting device 1000b can further be connected wirelessly with the wireless host 5000, such that the environment data generated by the environment-control box 2000, the extended environment-control box 2000a and the extended environment-control box 2000b can be transmitted in a wiring manner through the data-collecting device 1000, the extended data-collecting device 1000a and the extended data-collecting device 1000b to the hub 4010 and then the host 3010, and can also be transmitted in a wireless manner through the wireless host 5000. In some other embodiments not shown here, the wireless host 5000 and the host 3010 can be constructed in the sane apparatus.

For the data-collecting device of the present invention can uses the first transmit port and the second transmit port to connect the host and the other data-collecting devices so as to transmit the corresponding environment data generated by respective environment-control box to the host through the data-collecting devices connected in series. Hence, the complicated wiring problem as described in the background section can be resolved.

In addition, for the data-collecting device of the present invention can further include an extension port, so in the case that the data-collecting device is away from the host, the user can then apply the extension port to engage the wireless transmission module for performing wireless communication. In particular, the wireless transmission module can be built in the data-collecting device.

While the present invention has been particularly shown and described with reference to a preferred embodiment, it will be understood by those skilled in the art that various changes in form and detail may be without departing from the spirit and scope of the present invention.

What is claimed is:

1. A data-collecting device, applied to collect an environment data generated by an environment-control box and to transmit the environment data to a host, comprising:
a port, electrically coupled with the environment-control box for receiving the environment data;
a collector-processing unit, electrically coupled with the port for collecting the environment data via the port;
a first transmit port, electrically coupled with the collector-processing unit at one end thereof and the host at another end thereof via a first transmission cable so as to transmit the environment data collected by the collector-processing unit to the host; and
a second transmit port, electrically coupled with the collector-processing unit at one end thereof and at least one extended data-collecting device at another end thereof via a second transmission cable, the data-collecting device being further electrically coupled with an extended environment-control box;
wherein the extended data-collecting device is to collect an extended environment data generated by the extended environment-control box so as to transmit the extended environment data to the host via the data-collecting device.

2. The data-collecting device of claim 1, further including a display module electrically coupled with the collector-processing unit.

3. The data-collecting device of claim 2, wherein the display module further includes a display screen, an indicating light and a control button, the display screen being to display an outdoor environment data of the environment data, the outdoor environment data having an outdoor temperature and an outdoor humidity, the indicating light being to indicate one of the outdoor temperature and the outdoor humidity displayed on the display screen, the control button being to control displaying of the outdoor environment data on the display screen.

4. The data-collecting device of claim 1, further including an extension port electrically coupled with the collector-processing unit and electrically connecting a wireless transmission module.

5. The data-collecting device of claim 1, wherein the first transmit port and the second transmit port are both RS485 connectors.

6. The data-collecting device of claim 1, wherein the port is a DB9 connector.

7. The data-collecting device of claim 1, further including a power port electrically coupled with the collector-processing unit and the environment-control box.

8. A data-collecting system, comprising:
a host;
a data-collecting device, applied to collect an environment data generated by an environment-control box and to transmit the environment data to a host, comprising:
a port, electrically coupled with the environment-control box for receiving the environment data;
a collector-processing unit, electrically coupled with the port for collecting the environment data via the port;
a first transmit port, electrically coupled with the collector-processing unit at one end thereof and the host at another end thereof via a first transmission cable so as to transmit the environment data collected by the collector-processing unit to the host; and
a second transmit port, electrically coupled with the collector-processing unit; and
at least one extended data-collecting device, electrically coupled with the second transmit port via a second transmission cable, the extended data-collecting device being further electrically coupled with an extended environment-control box and being to collect an extended environment data generated by the extended environment-control box so as to transmit the extended environment data to the host via the data-collecting device.

9. The data-collecting system of claim 8, wherein the extended data-collecting device is formed by a plurality of the extended data-collecting devices connected in a serial manner.

10. The data-collecting system of claim 9, wherein each of the plurality of the extended data-collecting devices further includes:
an extended port, electrically coupled with the extended environment-control box for receiving the extended environment data;
an extended collector-processing unit, electrically coupled the extended port so as to collect the extended environment data via the extended port;
an extended first transmit port, electrically coupled the extended collector-processing unit; and
an extended second transmit port, electrically coupled with the collector-processing unit;
wherein the plurality of the extended data-collecting devices are connected in series by the respective extended first transmit ports and the respective extended second transmit ports, and the extended first transmit port of one of the plurality of the extended data-collecting devices is coupled electrically with the second transmit port via the second transmission cable.

11. The data-collecting system of claim 8, further including a hub electrically coupled with the host, the data-collecting device being formed as a plurality of the same data-collecting devices, the extended data-collecting device being formed as a plurality of the same extended data-collecting devices, a first transmit port of one of the plurality of the data-collecting devices being electrically coupled with the hub via the first transmission cable, an extended first transmit port of one of the plurality of the extended data-collecting devices being electrically coupled with the second transmit port of one of the plurality of the data-collecting devices via the second transmission cable.
